(19) United States
(12) Patent Application Publication
(10) Pub. No.: US 2021/0288375 A1
(43) Pub. Date: Sep. 16, 2021

(54) Reinforced-End Battery Cell Spacer

(71) Applicant: Silgan Containers LLC, Woodland Hills, CA (US)

(72) Inventor: Gerald James Baker, Wauwatosa, WI (US)

(21) Appl. No.: 17/337,041

(22) Filed: Jun. 2, 2021

Related U.S. Application Data
(63) Continuation of application No. PCT/US2019/067565, filed on Dec. 19, 2019.
(60) Provisional application No. 62/782,913, filed on Dec. 20, 2018.

(51) Int. Cl. H01M 50/291; H01M 50/293; H01M 50/213

(52) U.S. Cl. CPC H01M 50/291; H01M 50/213; H01M 50/293

(57) ABSTRACT

A one-piece, metal, reinforced-end battery cell spacer. The spacer replaces battery cells within a battery cell array, such as a lithium battery cell array. This permits a reduction in the power density and weight of the array by providing a rigid spacer to prevent movement of the battery cells relative to each other.

### CROSS-REFERENCE TO RELATED PATENT APPLICATION

The present application is a continuation of International Patent Application No. PCT/US2019/067565, filed Dec. 19, 2019, which claims the benefit of and priority to U.S. Provisional Application No. 62/782,913 filed on Dec. 20, 2018, which is incorporated herein by reference in its entirety.

### BACKGROUND

A typical battery cell array includes a plurality of battery cells arranged into a given volume having a predetermined set of dimensions. However, depending upon the application, it may be desirable to maintain the volume and dimensions of the array but to reduce the power density and weight of the array. This can be accomplished by replacing a predetermined number of battery cells with cylindrical spacers having outside dimensions substantially the same as the battery cells. Such spacers are required to have sufficiently rigid tops and bottoms to maintain the separation of battery cells within an array when the array is subjected to dynamic forces such as those within a vehicle.

### SUMMARY

A one-piece, metal, reinforced-end battery cell spacer. The spacer includes a circular bottom including a planar circular portion. A central axis passes through the center of the circular portion perpendicular thereto. A planar ring portion is centered on the central axis, and an angled wall extends between the ring portion and the circular portion to offset the circular portion from the ring portion. This arrangement provides for an indent in the bottom of the spacer. The spacer also includes a cylindrical side-wall centered on the central axis and extending from the ring portion to a top transition. A curved top portion extends from the top transition toward the central axis and into the volume defined by the cylindrical wall. The top portion includes a tapered wall located within the volume defined by the cylindrical wall.

### BRIEF DESCRIPTION OF THE DRAWINGS

FIG. 1 is a perspective view of a battery cell spacer;

FIG. 2 is a side view of the spacer;

FIG. 3 is a top view of the spacer;

FIG. 4 is a bottom view of the spacer;

FIG. 5 is a cross-sectional view taken along line 5-5 of FIG. 2;

FIG. 6 is a cross-sectional view taken along line 6-6 of FIG. 2;

FIG. 7 is a cross-sectional view taken along line 7-7 of FIG. 2; and

FIG. 8 is two dimensioned drawings of a side cross-sectional view of the spacer.

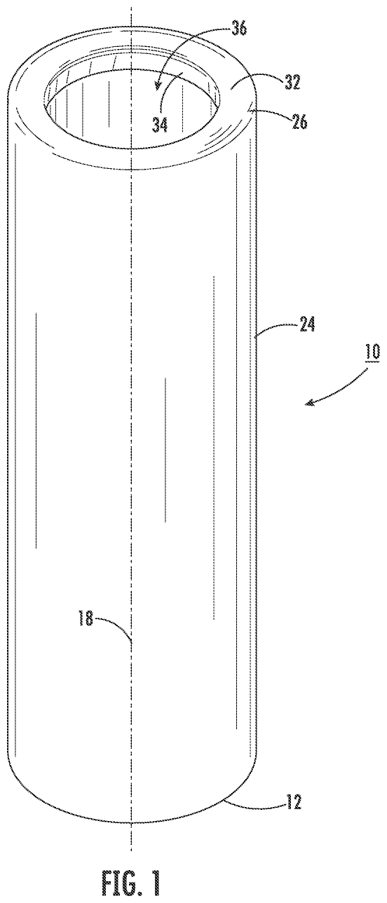

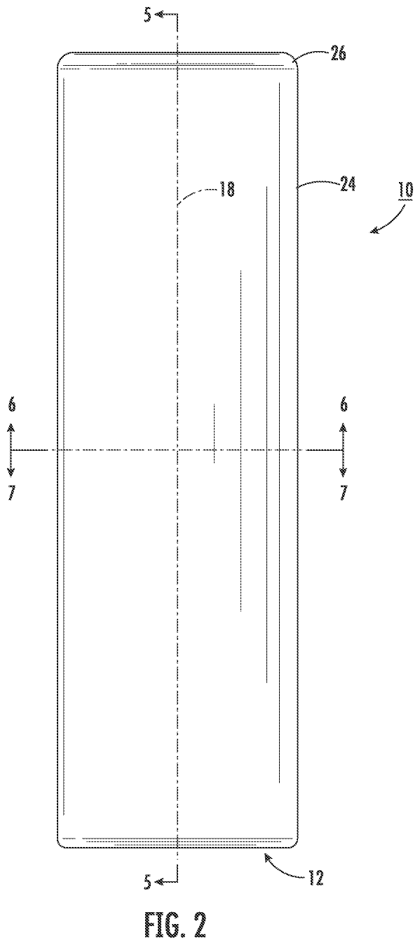

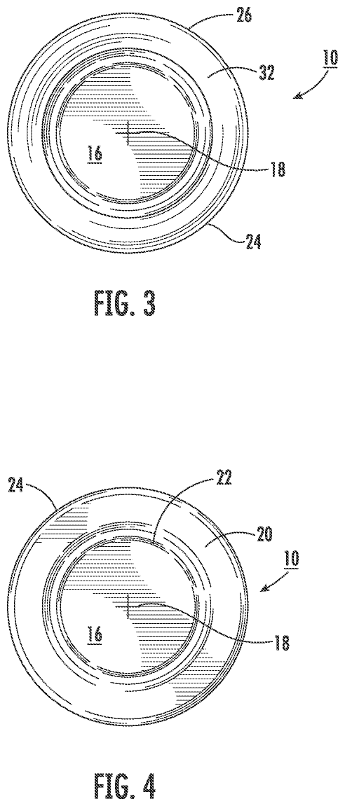

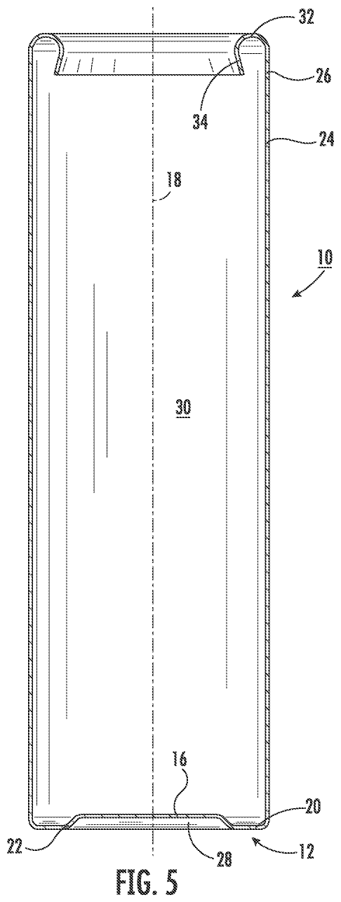

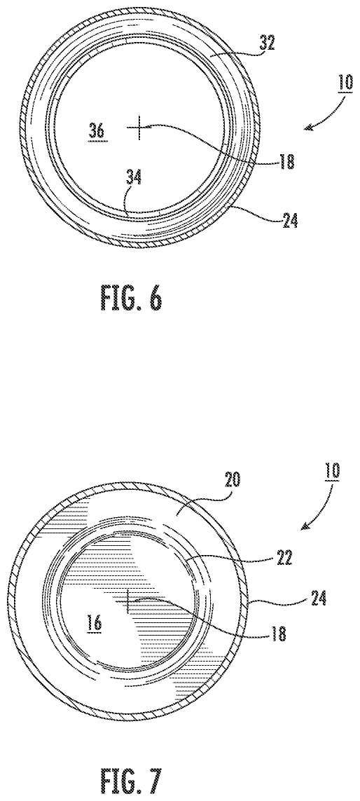

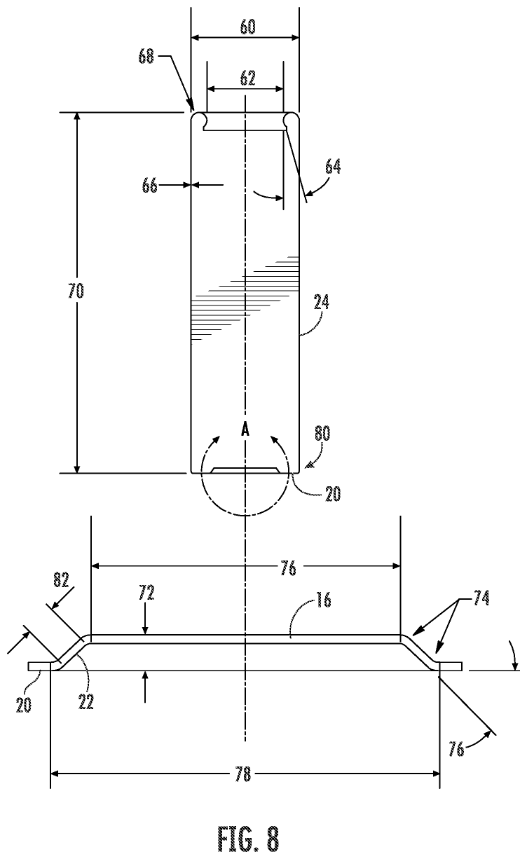

### DETAILED DESCRIPTION

The figures illustrate a one-piece, metal, reinforced-end battery cell spacer 10. As is shown, the container includes a circular bottom 12 having an outside diameter 60 which may be between 0.8 and 0.830 inches, and is preferably 0.827 inches. The bottom includes a planar circular portion 16 having a diameter 76 between 0.5 and 0.510 inches, and is preferably 0.507 inches. A central axis 18 passes through the center of the circular portion 16 perpendicular thereto. A planar ring portion 20 is centered on the central axis 18 and extends inwardly from the outside diameter to an inside diameter 78 of between 0.580 and 0.595 inches, and is preferably 0.587 inches.

An angled wall 22 extends between the circular portion 16 and the ring portion 20 and has a length 78 between 0.054 and 0.059 inches long, and preferably 0.0565 inches long. The wall 22 is preferably inclined at an angle between 40 and 50 degrees and preferably 45 degrees from the circular portion 16 and the ring portion 20 such that the circular portion 16 is parallel to and offset from the ring portion 20 a length 72 between 0.039 and 0.041 inches, and preferably 0.04 inches. Additionally, the bend radius 74 between the angled wall 22 and the circular and ring portions 16, 22 is between 0.017 and 0.023 inches, and preferably 0.02 inches.

A cylindrical side-wall 24 is centered on the central axis 18 and extends from the outside diameter of the circular bottom 12 at a right angle from the ring portion 20 to a top transition 26 such that the circular portion 16, ring portion 20 and angled wall 22 form an indentation 28 in the circular bottom 12 extending into a volume 30 defined by the cylindrical side-wall 24. The distance 70 from the circular bottom 12 and the top transition 26 is between 2.7 and 2.8 inches, and preferably 2.756 inches. Additionally, the bend radius 80 between the side-wall 24 and the ring portion 20 is between 0.017 and 0.023 inches, and preferably 0.02 inches.

A curved top portion 32 extends from the top transition 26 toward the central axis 18, into the volume 30 defined by the cylindrical side-wall 24 and includes a tapered wall 34 located within the volume 30 defined by the cylindrical side-wall 24. The curved portion of the top portion 32 has a radius 68 between 0.057 and 0.063 inches, and is preferably 0.060 inches. The tapered wall 34 is tapered at an angle 64 of between 10 and 20 degrees relative to the cylindrical side-wall 24, and preferably the angle 64 is 15 degrees. The curved top portion 32 defines an opening 36 into the spacer 10 having a diameter between 0.575 and 0.6 inches, and is preferably 0.587 inches.

Preferably, the spacer 10 is fabricated from sheet steel such that the side-wall has a width 66 between 0.011 and 0.012 inches, and preferably 0.0119 inches. If a material having a different strength that steel were used for the spacer 10 e.g. plastic or aluminum, the wall thicknesses, and dimensions of those portions of the spacer adding rigidity would be modified accordingly.

In a specific embodiment, the bottom portion of the spacer 10 is shaped similar to the top portion of the spacer shown in the exemplary figures.

In an alternative embodiment, the spacer 10 would retain its overall height and diameter, but the circular bottom 12 would be replaced with a curved bottom portion substantially the same as the curved top portionn.

What is claimed is:

1. A one-piece, metal, reinforced-end battery cell spacer comprising:
a circular bottom having an outside diameter, the bottom including a planar circular portion having a first diameter wherein a central axis passes through the center of the circular portion perpendicular thereto, a planar ring portion centered on the central axis and extending from a second diameter to the outside diameter, and an angled wall which extends between the ring portion to the circular portion between the first and second diameters such that the circular portion is offset from the ring portion;
a cylindrical side-wall centered on the central axis and extending from the outside diameter at a right angle from the ring portion to a top transition such that the circular portion, ring portion and angled wall form an indentation in the circular bottom extending into a volume defined by the cylindrical side-wall; and
a curved top portion extending from the top transition toward the central axis, into the volume defined by the cylindrical wall and including tapered wall located within the volume defined by the cylindrical wall.

2. The spacer of claim 1 wherein a portion of the curved top is round and has a radius of 0.060 inches.

3. The spacer of claim 2, wherein the second diameter is 0.587 inches.

4. The spacer of claim 3, wherein the angled wall formed at a 45 degree angle relative to the circular portion and the ring portion.

5. The spacer of claim 4, further comprising a first round transition portion extending between the ring portion and the angled portion with the round portion having a radius of 0.02 inches.

6. The spacer of claim 5, further comprising a second round transition portion extending between the circular portion and the angled portion with the round portion having a radius of 0.02 inches.

7. The spacer of claim 6, wherein the cylindrical side-wall has an outside diameter of 0.827 inches.

8. The spacer of claim 7, wherein the curved top portion defines an opening into the spacer wherein the opening has an inside diameter of 0.587 inches.

9. The spacer of claim 8, wherein the tapered wall is tapered at an angle of 15 degrees relative to the cylindrical side wall.

10. The spacer of claim 9, wherein the thickness of the side wall is 0.0119 inches.

11. The spacer of claim 10, wherein the spacer is fabricated from tin plate steel and has a thickness of 0.0119 inches.

12. A one-piece, metal, reinforced-end battery cell spacer comprising:
a circular bottom having an outside diameter, the bottom including a planar circular portion having a first diameter wherein a central axis passes through the center of the circular portion perpendicular thereto, a planar ring portion centered on the central axis and extending from a second diameter to the outside diameter, and an angled wall which extends between the ring portion to the circular portion between the first and second diameters such that the circular portion is offset from the ring portion;
a cylindrical side-wall centered on the central axis and extending from the outside diameter from the ring portion to a top transition such that the circular portion, ring portion and angled wall form an indentation in the circular bottom extending into a volume defined by the cylindrical side-wall; and
a curved top portion extending from the top transition toward the central axis, into the volume defined by the cylindrical wall and including tapered wall located within the volume defined by the cylindrical wall.

13. The spacer of claim 12 wherein a portion of the curved top is round and has a radius between 0.57 inches and 0.63 inches, and wherein the second diameter is between 0.575 inches and 0.6 inches.

14. The spacer of claim 12, wherein the angled wall formed at an angle between 40 degrees and 50 degrees relative to the circular portion and the ring portion, the spacer further comprising a first round transition portion extending between the ring portion and the angled portion with the round portion having a radius between 0.17 inches and 0.23 inches.

15. The spacer of claim 12, further comprising a second round transition portion extending between the circular portion and the angled portion with the round portion having a radius of 0.02 inches, wherein the cylindrical side-wall has an outside diameter between 0.8 inches and 0.83 inches.

16. The spacer of claim 12, wherein the curved top portion defines an opening into the spacer wherein the opening has an inside diameter between 0.575 inches and 0.6 inches, wherein the tapered wall is tapered at an angle between 10 degrees and 20 degrees relative to the cylindrical side wall.

17. The spacer of claim 12, wherein the thickness of the side wall is between 0.11 inches and 0.12 inches, and wherein the spacer is fabricated from tin plate steel and has a thickness between 0.11 inches and 0.12 inches.

18. A one-piece, metal, reinforced-end battery cell spacer comprising:
a cylindrical side-wall centered on a central axis and that defines an internal volume, the cylindrical side-wall extending from a top transition to a bottom transition;
a curved top portion extending from the top transition toward the central axis, into the volume defined by the cylindrical wall and including tapered wall located within the volume defined by the cylindrical wall; and
a curved bottom portion extending from the bottom transition toward the central axis, into the volume defined by the cylindrical wall and including tapered wall located within the volume defined by the cylindrical wall.

19. The spacer of claim 18 wherein a portion of the curved top is round and has a radius between 0.57 inches and 0.63 inches, wherein the second diameter is between 0.575 inches and 0.6 inches, wherein the angled wall formed at an angle between 40 degrees and 50 degrees relative to the circular portion and the ring portion, the spacer further comprising a first round transition portion extending between the ring portion and the angled portion with the round portion having a radius between 0.17 inches and 0.23 inches.

20. The spacer of claim 18, further comprising a second round transition portion extending between the circular portion and the angled portion with the round portion having a radius of 0.02 inches, wherein the cylindrical side-wall has an outside diameter between 0.8 inches and 0.83 inches, wherein the curved top portion defines an opening into the spacer wherein the opening has an inside diameter between 0.575 inches and 0.6 inches, wherein the tapered wall is tapered at an angle between 10 degrees and 20 degrees relative to the cylindrical side wall, wherein the thickness of the side wall is between 0.11 inches and 0.12 inches, and wherein the spacer is fabricated from tin plate steel and has a thickness between 0.11 inches and 0.12 inches.
